(19) United States
(12) Patent Application Publication
(10) Pub. No.: US 2019/0213678 A1
(43) Pub. Date: Jul. 11, 2019

(54) METHOD AND APPARATUS FOR TRADING FINANCIAL INSTRUMENTS

(71) Applicant: ONEUP TRADER LLC, Wilmington, DE (US)

(72) Inventor: Sattam ALSABAH, Sharq (KW)

(73) Assignee: ONEUP TRADER LLC, Wilmington, DE (US)

(21) Appl. No.: 15/935,594

(22) Filed: Mar. 26, 2018

Related U.S. Application Data
(60) Provisional application No. 62/615,571, filed on Jan. 10, 2018.

(51) Int. Cl. G06Q 40/04

(52) U.S. Cl. CPC G06Q 40/04

(57) ABSTRACT

Apparatus and methods for trading financial instruments is disclosed. An evaluation trading account for a customer in a simulated trading environment is established. Multiple evaluation trade requests, each for at least one contract, are received over multiple trading days. The real-time market value for each contract in each evaluation trade request received is determined. The evaluation trade requests are executed in the simulated trading environment based on the determined real-time market value for each contract. An account contract list and an account balance of the evaluation trading account are updated based on the execution of each evaluation trade request. A determination is made as to whether the evaluation account satisfies a set of evaluation trading account rules. If the evaluation account satisfies the set of evaluation trading account rules, a funded trading account is established in a real-world trading environment.

### CROSS-REFERENCE TO RELATED APPLICATION

This application claims priority benefit to U.S. Provisional Application Ser. No. 62/615,571 entitled “Method and Apparatus for Trading Financial Instruments” filed Jan. 10, 2018, the entirely of which is hereby incorporated herein by reference.

### FIELD OF THE INVENTION

The disclosure relates generally to financial instruments and, more specifically, to trading financial instruments.

### BACKGROUND

Traders buy and sell financial instruments on an open market over an exchange. Financial instruments include stocks, bonds, options, contracts, futures (e.g., currency futures, agricultural futures, energy futures, metal futures), and other financial instruments. The exchange provides traders a means by which to execute a trade. Sellers of a financial instrument can offer their financial instrument on the exchange at a particular price, and buyers can accept the offer and purchase the financial instrument. Likewise, buyers can offer a particular price for a financial instrument, and sellers of the financial instrument can accept the price to execute the trade. An exchange can operate over a network, where buyers and sellers can access the network to buy and sell financial instruments. Trading, however, involves risks, such as financial risks. For example, traders can lose money by selling a financial instrument for less than what they bought it for. Some systems allow for simulated trading whereby users can place trades in simulated environments for a fee. The systems allow the users to practice their trading strategies without taking on as much financial risk. These systems, however, have drawbacks.

### SUMMARY

In some embodiments, a method for qualifying traders by one or more computing devices includes establishing an evaluation trading account for a customer in a simulated trading environment. The evaluation trading account can include an account contract list, an account balance, an account profit target amount, an account maximum drawdown amount, and an account daily loss limit amount. The evaluation trading account can be associated with a set of evaluation trading account rules. The method can include receiving a plurality of evaluation trade requests, each for at least one contract, for the evaluation trading account over a plurality of trading days. The method can also include determining a real-time market value for each contract received in the plurality of evaluation trade requests. The method can further include executing the plurality of evaluation trade requests in the simulated trading environment based on the determined real-time market value for each contract. The method can also include updating the account contract list and the account balance of the evaluation trading account based on the execution of each of the plurality of evaluation trade requests.

The method can include determining whether the evaluation account satisfies the set of evaluation trading account rules. The method can also include establishing a funded trading account for the customer in a real-world trading environment based on determining that the evaluation account satisfies the evaluation trading account rules. The funded trading account can allow for contract trading in the real-world. For example, once the evaluation account is determined to satisfy the set of evaluation trading account rules, no additional training steps are required before a funded trading account is established that allows for trading in the real-world.

In some examples, one or more computing devices are configured to establish an evaluation trading account for a customer in a simulated trading environment. The one or more computing devices are configured to receive a plurality of evaluation trade requests, each for at least one contract, for the evaluation trading account over a plurality of trading days. The one or more computing devices are configured to determine a real-time market value for each contract received in the plurality of evaluation trade requests, and to execute the plurality of evaluation trade requests in the simulated trading environment based on the determined real-time market value for each contract. The one or more computing devices are configured to update the account contract list and the account balance of the evaluation trading account based on the execution of each of the plurality of evaluation trade requests.

The one or more computing devices can also be configured to determine whether the evaluation account satisfies a set of evaluation trading account rules. The one or more computing devices can be configured to establish a funded trading account for the customer in a real-world trading environment based on determining that the evaluation account satisfies the evaluation trading account rules.

In some examples, a non-transitory, computer-readable storage medium includes executable instructions. The executable instructions, when executed by one or more processors, can cause the one or more processors to: establish an evaluation trading account for a customer in a simulated trading environment; receive a plurality of evaluation trade requests, each for at least one contract, for the evaluation trading account over a plurality of trading days; determine a real-time market value for each contract received in the plurality of evaluation trade requests; execute the plurality of evaluation trade requests in the simulated trading environment based on the determined real-time market value for each contract; and update the account contract list and the account balance of the evaluation trading account based on the execution of each of the plurality of evaluation trade requests.

The executable instructions, when executed by one or more processors, can also cause the one or more processors to determine whether the evaluation account satisfies a set of evaluation trading account rules, and establish a funded trading account for the customer in a real-world trading environment based on determining that the evaluation account satisfies the evaluation trading account rules.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a computer system in accordance with some embodiments;

FIG. 2 is a block diagram of the application server of the computer system of FIG. 1 in accordance with some embodiments;

FIG. 3 illustrates a messaging scheme among computing devices of FIG. 1 in accordance with some embodiments;

FIG. 4 is a flowchart of an example method that can be carried out by the computer system of FIG. 1 in accordance with some embodiments;

FIG. 5 is a flowchart of another example method that can be carried out by the computer system of FIG. 1 in accordance with some embodiments; and

FIG. 6 is a flowchart of yet another example method that can be carried out by the computer system of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

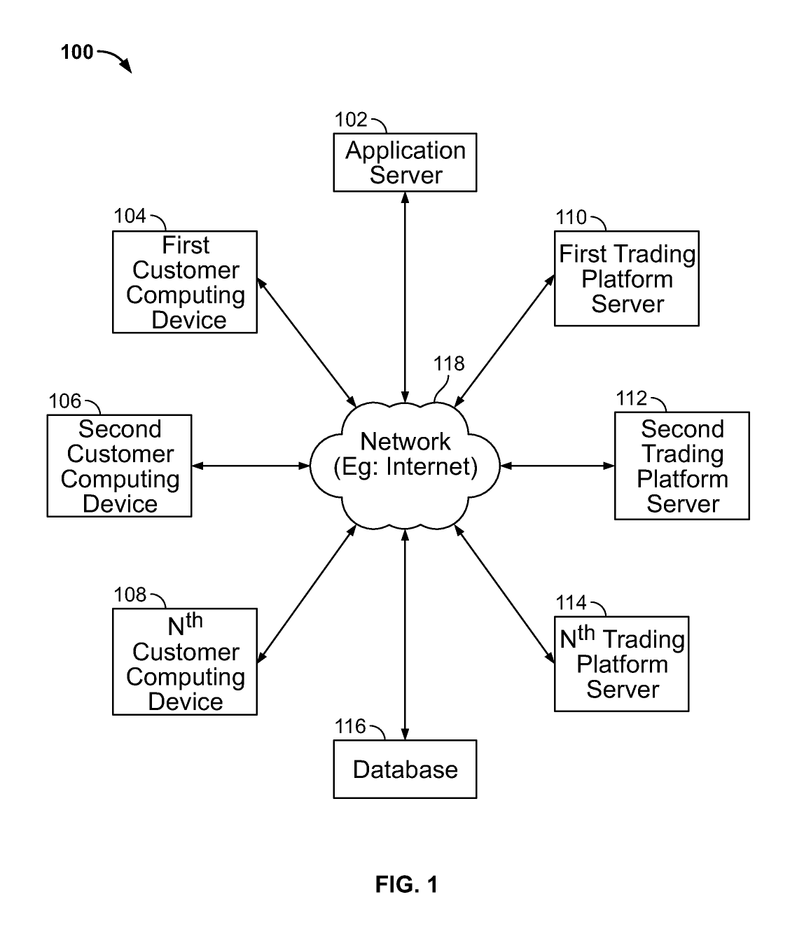

Turning to the drawings, FIG. 1 illustrates a block diagram of a computer system 100 that includes application server 102, multiple computing devices 104, 106, 108, multiple trading platform servers 110, 112, 114, and database 116 operably connected to network 118. Application server 102, first computing device 104, second computing device 106, Nth computing device 108, first trading platform server 110, second trading platform server 112, and Nth trading platform server 114 can each be any suitable computing device that includes any suitable hardware or hardware and software combination suitable for processing and handling information, such as transmitting and receiving data. For example, each of application server 102, multiple computing devices 104, 106, 108, and multiple trading platform servers 110, 112, 114 can be a computer, a workstation, a laptop, a mobile device such as a cellphone, a cloud-based server, or any other suitable device. Each can include one or more processors, one or more field-programmable gate arrays (FPGAs), one or more application-specific integrated circuits (ASICs), one or more state machines, digital circuitry, or any other suitable circuitry. Although FIG. 1 illustrates three customer computing devices 104, 106, 108, the number of customer computing devices 104,106, 108 in computer system 100 can be more or less. Similarly, although FIG. 1 illustrates three trading platform servers 110, 112, 114, the number of trading platform servers 110, 112, 114 in computer system 100 can be more or less.

Application server 102 is operable to communicate with database 116. For example, application server 102 can store data to, and read data from, database 116. Database 116 can be a remote storage device, such as a cloud-based server, a memory device on another application server, a networked computer, or any other suitable remote storage. Although shown remote to application server 102, in some examples database 116 can be a local storage device, such as a hard drive, a non-volatile memory, or a USB stick. For example, database 116 can be a storage device local to application server 102.

Application server 102 can communicate with database 116 over network 118. Network 118 can be a WiFi® network, a cellular network such as a 3GPP® network, a Bluetooth® network, a satellite network, or any other suitable network. Network 118 can provide access to, for example, the Internet.

Application server 102 can also communicate with customer first computing device 104, second customer computing device 106, and Nth customer computing device 108 over network 118. Similarly, first customer computing device 104, second customer computing device 106, and Nth customer computing device 108 are operable to communicate with application server 102 over network 118. For example, Application server 102 can receive data (e.g., messages) from, and transmit data to, first customer computing device 104, second customer computing device 106, and Nth customer computing device 108.

Application server 102 is also operable to communicate with first trading platform server 110, second trading platform server 112, and Nth trading platform server 114. For example, Application server 102 can receive data from, and transmit data to, first trading platform server 110, second trading platform server 112, and Nth trading platform server 114.

Each of first trading platform server 110, second trading platform server 112, and Nth trading platform server 114 either is, or provides access to, a real-world exchange where contracts can be traded. In other words, the trading platform servers 110, 112, 114 allow for the execution of contract trades. For example, a seller can place contracts for sale via the trading platform servers 110, 112, 114. Similarly, a buyer can buy contracts via the trading platform servers 110, 112, 114. Each of the trading platform servers 110, 112, 114 provide prices for financial securities that it provides for selling. For example, the trading platform servers 110, 112, 114 can provide a real-time price quote for a listed contract. Trading platform servers 110, 112, 114 can also provide other information necessary to allow for the execution of a trade, such as buyer and seller information, an execution price, an indication of the contract traded, and the like.

Application server 102 can include a trading simulation application that allows users (e.g., customers) to trade in a simulated trading environment. The trading simulation application can include a graphical user interface (GUI), such as a website, for presenting the functionality and information pertaining to the trading simulation application to one or more of first customer computing device 104, second customer computing device 106, and Nth customer computing device 108. Appendix A includes images of a website that can be included in the trading simulation application, for example.

The trading simulation application can allow for users to create an account that allows them to trade in a simulated environment. The trading simulation application can include rules that the users must follow. If the users follow the rules and meet certain goals, the users are provided access to a trading platform that allows trading of financial securities in the real world. For example, if the users follow the rules and meet the goals, the users can be provided access to funded accounts provided by one or more of trading platform servers 110, 112, 114. The funded account can be an account whereby a third-party provides the initial funding for the account. If the users fail to follow the rules in the simulated environment, or fail to meet the goals, the trading simulation application can suspend, cancel, or reset the user's evaluation trading account allowing them to trade in the simulated environment.

For example, the trading simulation application can establish an evaluation trading account for a customer in a simulated trading environment. Although the simulated trading environment can reflect real-time prices of contracts, no money is exchanged between the customer and another party for simulated trades. Instead, an evaluation trading account of the customer can be updated based on the simulated trades. The evaluation trading account can allow trading during an evaluation period (e.g., a week, 15 days, a month). The evaluation account can include one or more of an account contract list, an account balance, an account profit target amount, an account maximum drawdown amount, an account daily loss limit amount, and a maximum number of daily trades.

The account contract list is a listing of contracts currently associated with the customer's account. For example, if the customer buys ten contracts for gold, the customer's contract list will reflect the ten contracts for gold.

The account balance is a running balance of the money value of the customer's account. For example, the account balance can be credited with an initial amount. As the customer buys and sells contracts, the account balance reflects the amount of money associated with the customer's evaluation trading account as a result of those trades.

The account profit target amount is a target amount of profit a customer must make before the end of the evaluation trial period. For example, the end value of the account balance can be compared to the beginning balance of the account balance to determine the account's profit. The evaluation trial period can be a number of days, such as a number of trading days in a real-world market exchange. For example, the evaluation trial period can be 15 trading days.

The account maximum drawdown amount is the maximum amount of value that the account balance is allowed to drop to before further evaluation trade requests are denied. For example, if the account balance drops to below the maximum drawdown amount, no further evaluation trade requests will be executed. As another example, if the account balance loses value by the account maximum drawdown amount or more, no further evaluation trade requests will be executed. In addition, the customer's evaluation trading account can be suspended, cancelled (e.g., terminated), or reset.

In some examples, the trading simulation application can determine if executing a received evaluation trade request will cause the account balance to go below the maximum drawdown amount. If it is determined that executing the evaluation trade request will cause the account balance to go below the account maximum drawdown amount, the evaluation trade request can be rejected.

In some examples, the maximum drawdown amount increases as the account balance increases. For example, the maximum drawdown amount can “trail” the account balance by an amount. In some examples, the maximum drawdown amount will trail up as the account balance increases, but will not trail down as the account balance decreases.

The account daily loss limit amount is the maximum amount of value that the account balance is allowed to drop in any single trading day. For example, if the account balance loses value by at least the account daily loss limit amount, no further evaluation trade requests will be executed for that trading day. For example, application server 102 can ignore or deny any further evaluation trade requests from the customer.

In some examples, the trading simulation application can determine if executing a received evaluation trade request will cause the account balance to drop below the account daily loss limit amount in the current trading day. If it is determined that executing the evaluation trade request will cause the account balance to drop below the account daily loss limit amount in the current trading day, the evaluation trade request can be rejected

The maximum number of daily trades is the maximum number of trades allowed in any single trading day. For example, once a customer has executed the maximum number of trades, no further evaluation trade requests will be executed for that trading day. For example, application server 102 can ignore or deny any further evaluation trade requests from the customer.

In some examples, the evaluation trading account also includes a requirement that the account list not include more than a maximum position size. The maximum position size can be the greatest monetary value of all positions (e.g., contracts) held in the account list. The trading simulation application can determine if an evaluation trade request will cause the account list to surpass the maximum position size. If the trading simulation application determines that an evaluation trade request will cause the account list to surpass the maximum position size, the trading simulation application can reject the evaluation trade request.

In some examples, the evaluation trading account also includes a requirement that a net profit of the account balance, for any threshold number of trading days during the evaluation trial period, meets or exceeds a threshold percentage of a largest net profit of the account balance for any trading day of the evaluation trial period. For example, the trading simulation application can determine a net profit over three trading days of the evaluation period. The trading simulation application can also determine the largest net profit over any single day of the evaluation period. In one example, a threshold percentage of 80% is used. In this example, the net profit over the three trading days must be at least 80% of the largest net profit over any single day for the rule to be satisfied. In some examples, this rule must be satisfied for every threshold number of trading days (e.g., three) of the evaluation period.

In some examples, the evaluation trading account also includes an account reset fee. The account reset fee is an amount of money the customer must pay if the evaluation trading account is suspended, reset, or cancelled. For example, in some examples the customer must pay the account reset fee if the account balance reaches the maximum drawdown amount.

In some examples, the evaluation trading account also includes an account fee. The account fee is an amount of money that the customer must pay to maintain the evaluation trading account. The account fee can be a monthly account fee that the customer is required to pay every 30 days, or once a month, for example. Failure to pay the account fee can result in the evaluation trading account being suspended, reset, or cancelled.

Table 1 below shows examples of evaluation trading accounts under the categories of “Novice,” “Beginner,” “Advanced,” “Professional,” and “Expert.”

TABLE 1

| | | BE- | AD- | PROFES- | |
|---|---|---|---|---|---|
| | NOVICE | GINNER | VANCED | SIONAL | EXPERT |
| Max No. | 3 | 6 | 12 | 15 | 25 |
| Contracts | | | | | |
| Profit | $1,500 | $3,000 | $6,000 | $9,000 | $15,000 |
| Target | | | | | |
| Max | $1,500 | $2,500 | $3,500 | $5,000 | $5,500 |
| Drawdown | | | | | |
| Daily Loss | $500 | $1,250 | $2,500 | $4,000 | $5,000 |
| Limit | | | | | |
| Account | $100 | $100 | $100 | $100 | $100 |
| Reset Fee | | | | | |
| Monthly | $95 | $120 | $240 | $300 | $500 |
| Fee | | | | | |

Table 2 below shows other examples of evaluation trading accounts.

TABLE 2

| | | BE- | AD- | PROFES- | |
|---|---|---|---|---|---|
| | NOVICE | GINNER | VANCED | SIONAL | EXPERT |
| Max No. | 3 | 6 | 12 | 15 | 25 |
| Contracts | | | | | |
| Profit | $1,500 | $3,000 | $6,000 | $9,000 | $15,000 |
| Target | | | | | |
| Max | $1,500 | $2,500 | $3,500 | $5,000 | $5,500 |
| Drawdown | | | | | |
| Daily Loss | $500 | $1,250 | $2,500 | $4,000 | $5,000 |
| Limit | | | | | |
| Account | $100 | $100 | $100 | $100 | $100 |
| Reset Fee | | | | | |
| Monthly | $125 | $150 | $300 | $350 | $650 |
| Fee | | | | | |

Once a customer has an established account, the trading simulation application can receive evaluation trade requests. Each evaluation trade request can include a trade request for at least one contract. For example, each evaluation trade request can include one or more requests to sell one or more contracts, one or more requests to buy one or more contracts, or any combination of the foregoing.

Application server 102 can determine the real-time market value for each contract received in the evaluation trade requests. For example, the trading simulation application can obtain a real-time price for the contract from one or more of trading platform servers 110, 112, 114. Application server 102 can execute the evaluation trade requests in the simulated trading environment based on the determined real-time market value for each contract. Upon execution of the trade, application server 102 can update the customer's evaluation trading account. For example, application server 102 can update the account contract list by adding a bought contract, or by deducting a sold contract. Similarly, the trading simulation application can update the account balance of the evaluation trading account by adding the value of a sold contract, or by deducting the value of a bought contract.

The trading simulation application can also associate evaluation trading accounts with one or more evaluation trading account rules. The evaluation trading account rules can include trading requirements that the customer must follow before any goals are reached. Failure to follow the evaluation trading account rules can lead to a customer's evaluation trading account being suspended, cancelled, or reset. For example, the evaluation trading account rules can include a requirement that the customer attempt to execute at least one trade over the evaluation trial period, such as a number of trading days (e.g., 15).

Another evaluation rule can require that, at the end of a number of days, the account balance must be greater than an initial account balance by at least the account profit target amount. If the account's profit meets or exceeds the account profit target amount, the customer has satisfied the rule. If the account's profit does not meet or exceed the account profit target amount, the customer has not satisfied the rule.

Yet another evaluation rule can require that the account balance not go below the account maximum drawdown amount during the evaluation period. For example, the trading simulation application can determine whether the account balance went below the account maximum drawdown amount during the evaluation period, and terminate the evaluation account if the account balance is determined to go below the account maximum drawdown amount.

At the end of the evaluation trial period, the trading simulation application can determine whether a customer's evaluation account satisfies one or more of the set of evaluation trading account rules. If the trading simulation application determines that the evaluation trading account rules have been satisfied, the trading simulation application can establish a trading account for the customer in a real-world trading environment, such as one provided by first trading platform server 110, second trading platform server 112, or Nth trading platform server 114.

In some examples, the trading simulation application can refer the customer to a trading company that offers a trading service for trading in a real-world environment that offers the funded account terms and profit sharing model of the account type selected by the customer. For example, if the trading simulation application determines that the evaluation trading account rules have been satisfied, the trading simulation application can certify that the customer has successfully completed the evaluation trial to companies that offer funded accounts and profit sharing models of the type that the customer selected. In some examples, if the evaluation trading account required an account fee, the account fee is refunded to the customer if a company offering a funded account of the type that the customer selected is not identified that will accept the customer. For example, if the customer, having successfully completed the evaluation, is not paired with a company offering the promised profit sharing model and funded account size, the account fee can be refunded.

In addition, in some examples the trading account established in the real-world trading environment is a funded trading account. The amount of funding can depend on the type of evaluation trading account the customer originally established. For example, a first account type can receive a funded account for a first amount (e.g., $25,000). A second account type can receive a funded account for a second amount, where the second amount can be greater than the first amount (e.g., $50,000). The different account types can have different account requirements, such as differing evaluation trading account rules that need to be satisfied for the evaluation to be successfully completed.

For example, a customer that signs up for a “Novice” account (see, e.g., Table 1 and Table 2) can receive a $25,000 funded account if the customer successfully completes the evaluation. As another example, a customer that signs up for a “Beginner” account can receive a $50,000 funded account if the customer successfully completes the evaluation. A customer that signs up for an “Advanced” account can receive a $100,000 funded account if the customer successfully completes the evaluation. A customer that signs up for a “Professional” account can receive a $150,000 funded account if the customer successfully completes the evaluation. A customer that signs up for an “Expert” account can receive a $250,000 funded account if the customer successfully completes the evaluation.

In some examples, each account can be associated with a profit sharing model, where the profits are based on trades in the real-world using the funded account. For example, each account can require that a first amount of money profited from trading with the funded account go to the user, while the customer will receive only a percentage of any profits after that. In some examples, a first account type is associated with a first profit sharing model (e.g., first $5,000 profits, and 50% profits thereafter go to customer), and a second account type is associated with a second profit sharing model (e.g., first $8,000 profits, and 80% profits thereafter go to customer).

In some examples, the higher the account fee for a type of account, the higher the profits may be that the customer can keep. For example, the first account type described above can require a first account fee (e.g., $95, and the second account type described above can require a second account fee that is higher than the first account fee (e.g., $125).

For example, the “Novice” account of Table 1 requires a $95 monthly fee, while the “Novice” account of Table 2 requires a $125 monthly fee. In one example, a customer that signs up for the “Novice” account of Table 1 and successfully completes the evaluation agrees to keep 100% of the first $5,000 earned trading in the funded account, and keep 50% of all profits earned after that. A customer that signs up for the “Novice” account of Table 2 and successfully completes the evaluation, however, can keep 100% of the first $8,000 earned trading in the funded account, and keep 80% of all profits earned after that.

In one example, a customer that signs up for the “Beginner” account of Table 1 and successfully completes the evaluation agrees to keep 100% of the first $5,000 earned trading in the funded account, and keep 50% of all profits earned after that. In one example, a customer that signs up for the “Beginner” account of Table 2 and successfully completes the evaluation agrees to keep 100% of the first $8,000 earned trading in the funded account, and keep 80% of all profits earned after that.

In one example, a customer that signs up for the “Advanced” account of Table 1 and successfully completes the evaluation agrees to keep 100% of the first $5,000 earned trading in the funded account, and keep 50% of all profits earned after that. In one example, a customer that signs up for the “Advanced” account of Table 2 and successfully completes the evaluation agrees to keep 100% of the first $8,000 earned trading in the funded account, and keep 80% of all profits earned after that.

In one example, a customer that signs up for the “Professional” account of Table 1 and successfully completes the evaluation agrees to keep 100% of the first $5,000 earned trading in the funded account, and keep 50% of all profits earned after that. In one example, a customer that signs up for the “Professional” account of Table 2 and successfully completes the evaluation agrees to keep 100% of the first $8,000 earned trading in the funded account, and keep 80% of all profits earned after that.

In one example, a customer that signs up for the “Expert” account of Table 1 and successfully completes the evaluation agrees to keep 100% of the first $5,000 earned trading in the funded account, and keep 50% of all profits earned after that. In one example, a customer that signs up for the “Expert” account of Table 2 and successfully completes the evaluation agrees to keep 100% of the first $8,000 earned trading in the funded account, and keep 80% of all profits earned after that.

In some examples, the trading simulation application can switch between the customer's evaluation account and a trading account in a real-world trading environment. For example, rather than allowing the customer to trade in a real-world trading environment after successfully completing an evaluation, the trading simulation application may instead allow the customer to continue trading in the simulated environment. Although the customer will be trading in the simulated environment, the customer's account can be associated with a profit sharing model, such as the profit sharing models discussed above. The customer may still obtain profits based on how the trades executed in the simulated environment would have fared in a real-world trading environment. Thus, for example, if after having successfully completed an evaluation, a company offering a funded account of the type that the customer has selected cannot be identified, the trading simulation application may allow the customer to trade in the simulated environment according to the same profit sharing model that the customer originally signed up for. In this manner, the customer may still earn trading profits regardless if they are placed with a trading account in a real-world trading environment.

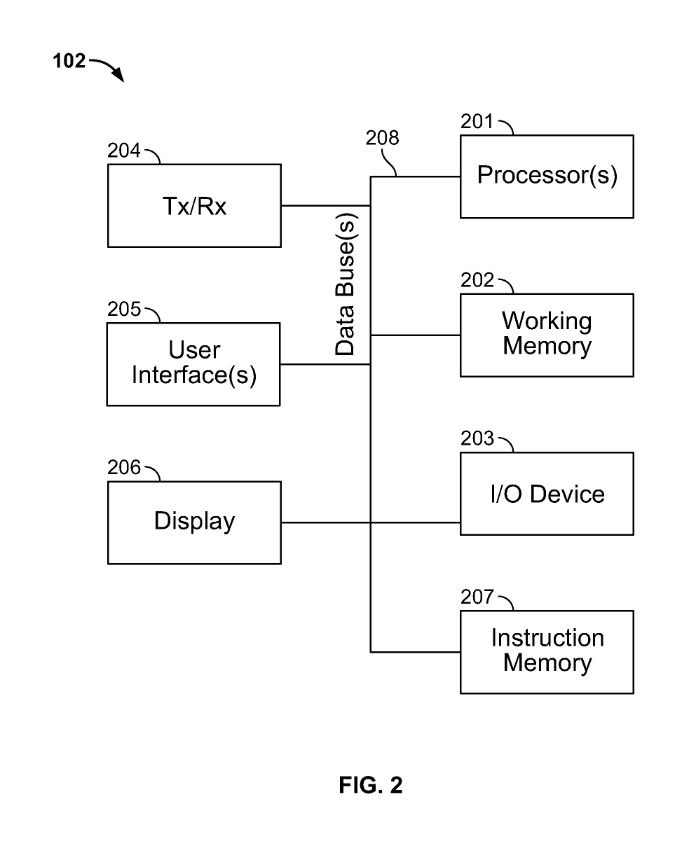

FIG. 2 illustrates the application server 102 of FIG. 1. Application server 102 can include one or more processors 201, working memory 202, one or more input/output devices 203, instruction memory 207, a transceiver 204, one or more user interfaces 205, a display 206, and one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 are configured to perform a certain function or operation by executing code, stored on instruction memory 207, embodying the function or operation. Processors 201 can be configured to perform one or more of any function, method, or operation disclosed herein.

Instruction memory 207 can store instructions that can be accessed (e.g., read) and executed by processors 201. For example, instruction memory 207 can include read-only memory (ROM) such as electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of application server 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

User interfaces 205 enable user interaction with application server 102. For example, user interfaces 205 can include the GUI described above with respect to FIG. 1. User interfaces 205 can be displayed on displays, such as display 206. In some examples, a user can interact with user interfaces 205 by engaging input-output devices 203.

Transceiver 204 allows for communication with a network, such as the network 118 of FIG. 1. For example, if network 118 is a cellular network, transceiver 204 is configured to allow communications with a cellular network. In some examples, transceiver 204 is selected based on the type of network 118 application server 102 will be operating in. Processors 201 is operable to receive data from, or send data to, network 118 via transceiver 204.

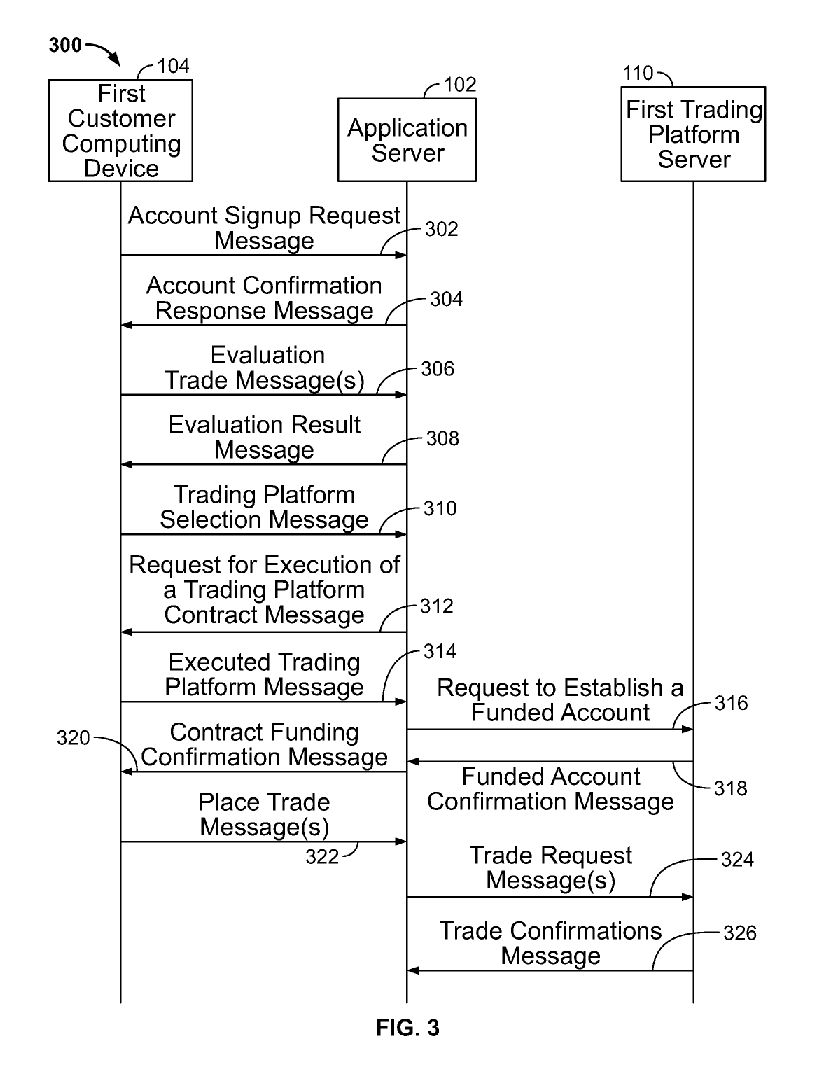

FIG. 3 illustrates an example messaging scheme among first customer computing device 104, application server 102, and first trading platform server 110. To begin, first customer computing device 104 transmits an account signup request message 302 to application server 102. The account signup request message can be a request to establish an evaluation trading account for a customer in a simulated trading environment. The application server 102 then responds with an account confirmation response message 304. The account confirmation response message 304 confirms that an evaluation trading account has been established for the customer. For example, evaluation trades associated with the established evaluation trading account are now allowed and can be executed.

First customer computing device 104 then transmits one or more evaluation trade messages 306 to application server 102. Each evaluation trade message 306 can include an evaluation trade request for at least one contract. First customer computing device 104 can transmit multiple evaluation trade messages 306 over multiple days of an evaluation period. At the conclusion of the evaluation time period, for example, application server 102 transmits to first customer computing device 104 an evaluation result message 308. The evaluation result message 308 can include an indication of whether the customer is awarded a funded trading account in a real-world trading environment. The decision as to whether a funded trading account is awarded to the customer can be based on determining that the evaluation account satisfied evaluation trading account rules. For example, if the evaluation account satisfies the evaluation trading account rules, the funded trading account is awarded. Otherwise, the funded trading account is not awarded.

Assuming the customer is awarded the funded trading account, first customer computing device 104 transmits a trading platform selection message 310. The trading platform selection message 310 can include a selection of a trading platform to execute real-world trades. For example, trading platform selection message 310 can select one of multiple trading platform servers 110, 112, 114 of FIG. 1. In this example, first trading platform server 110 is selected. In response, application server 102 transmits a request for execution of a trading platform contract message 312. The message can include, for example, a contract between the customer and the selected trading platform (e.g., first trading platform server 110) to allow for the creation of a trading account. In some examples, the customer is required to sign the contract. In response to the trading platform contract message 312, the first customer computing device 104 transmits an executed trading platform message 314 to application server 102. For example, the message can include a customer signed copy of the contract received in the request for execution of a trading platform contract message 312.

Application server 102 then transmits to first trading platform server 110 a request to establish a funded account message 316. The message can include any information necessary to establish a funded account for the customer, such as name, contact information, bank information, or any other appropriate information. First trading platform server 10 then responds to application server 102 with a funded account confirmation message 318. The funded account confirmation message 318 confirms that the funded trading account has been established for the customer. Application server 102 then transmits to first customer computing device 104 a contract funding confirmation message 320, confirming that the funded trading account has been established with first trading platform server 110. The contract funding confirmation message 320 can also include any information required to place real-world trades with first trading platform server 110, such as account information and the like.

First customer computing device 104 can then transmit one or more place trade messages 322 to application server 102, which include trade requests to trade one or more contracts through first trading platform server 110. For example, each place trade message 322 can include one or more requests to purchase or sell one or more contracts. In response, application server 102 provides one or more trade request messages 324 to first trading platform server 110 to execute one or more of the requested trades. First trading platform server 110 can then attempt to execute the trade. First trading platform server 110 then responds to application server 102 with one or more trade confirmation messages 326. Each trade confirmation message 326 can include an indication of whether a requested trade was successfully executed.

Although in this example first customer computing device 104 transmits place trade messages 322 to application server 102, in other examples first customer computing device 104 transmits the place trade messages 322 to first trading platform server 110. In these examples, first trading platform application server 110 can additionally or alternately transmit the trade confirmation messages 326 to first customer computing device 104.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

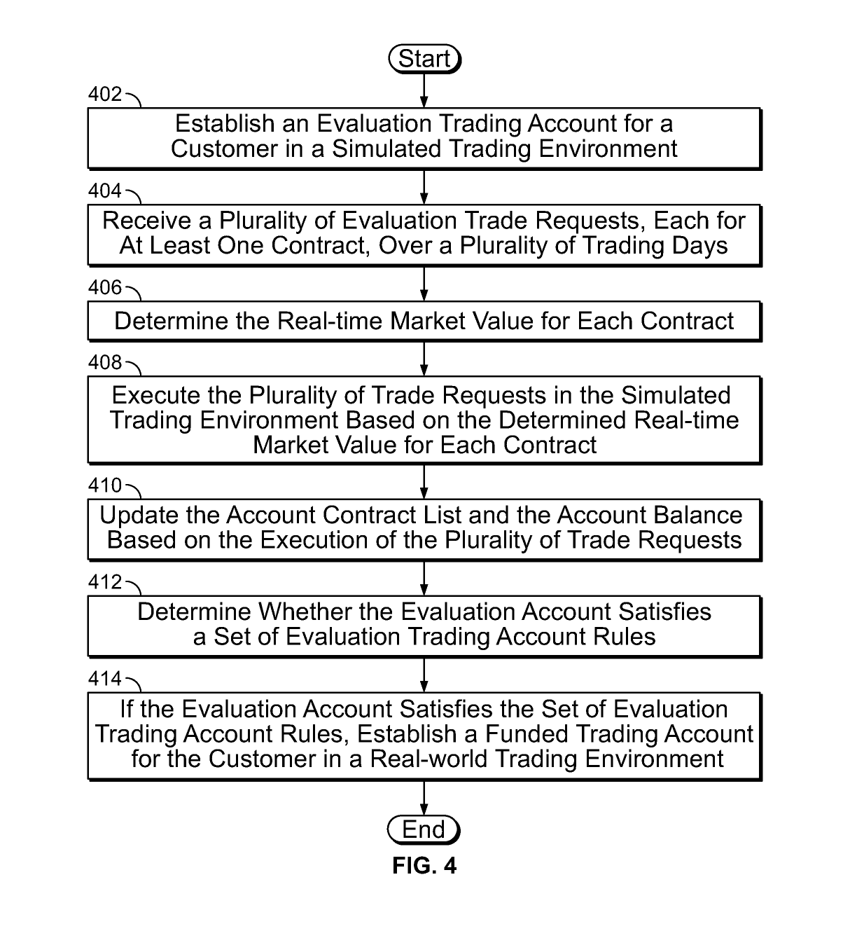

FIG. 4 is a flowchart of an example method that can be carried out by an application server, such as the application server 102 of FIG. 1. At step 402, an evaluation account is established in a simulated trading environment for a customer. At step 404, a plurality of evaluation trade requests are received over a plurality of trading days. Each evaluation trade request include a trade request for at least one contract. At step 406, the real-time market value for each contract is determined. For example, as each evaluation trade request is received, the real-time market value for the associated one or more contracts are determined.

At step 408, the plurality of evaluation trade requests are executed in the simulated trading environment based on the determined real-time market value for each contract. For example, an evaluation trade request to sell a number of contracts is executed by selling the number of contracts at the determined real-time market value. Likewise, an evaluation trade request to buy a number of contracts is executed by buying the number of contracts at the determined real-time market value. The evaluation trade requests can be executed as they are received.

At step 410, the account contract list and the account balance associated with the evaluation account are updated. For example, if a number of contracts are sold, the account contract list is updated by removing the number of contracts from the account contract list. The account balance can be updated by adding the value of the sold contracts. If, instead, a number of contracts are bought, the account contract list is updated by including the number of contracts from the account contract list. The account balance can be updated by subtracting the value of the sold contracts.

At step 412, a determination of whether the evaluation account satisfies a set of evaluation trading account rules is determined. The evaluation trading account rules can include any evaluation trading account rules discussed above, for example. At step 414, if the evaluation account satisfies the set of evaluation trading account rules, a funded trading account for the customer is established in a real-world trading environment.

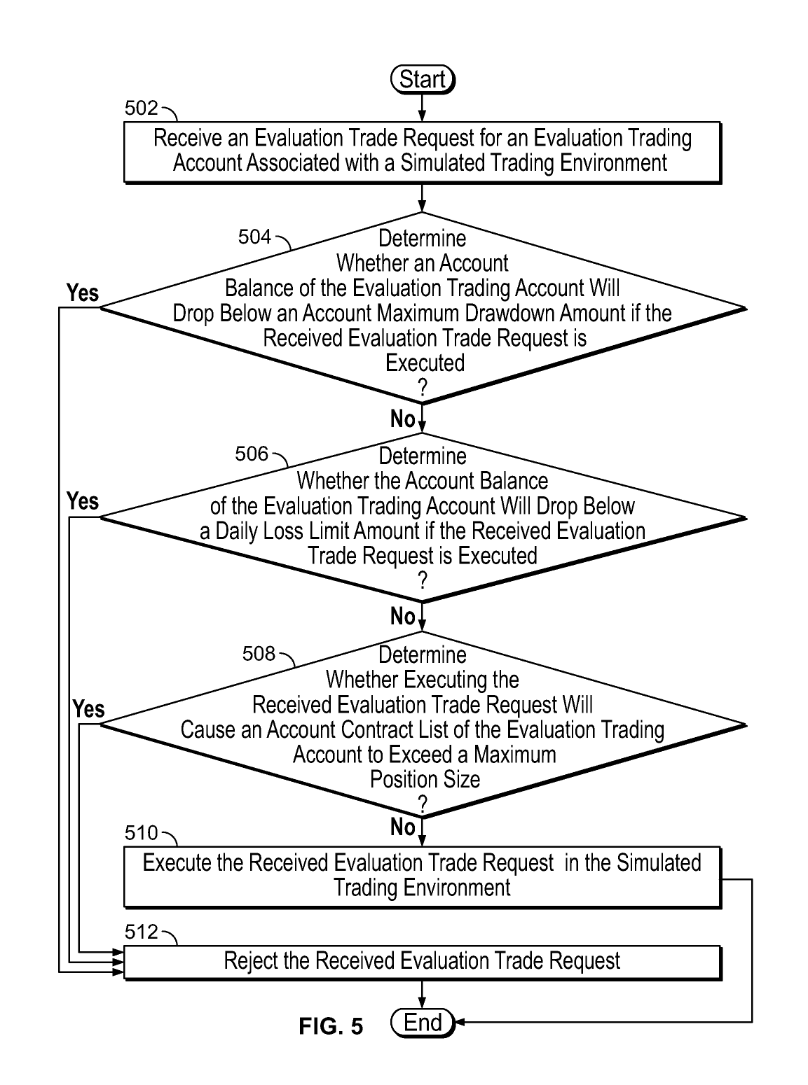

FIG. 5 is a flowchart of another example method that can be carried out by an application server, such as the application server 102 of FIG. 1. At step 502, an evaluation trade request is received for an evaluation trading account associated with a simulated trading environment. At step 504, a determination is made as to whether an account balance of the evaluation trading account will drop below an account maximum drawdown amount if the received evaluation trade request is executed. If it is determined that the account balance will drop below the account maximum drawdown amount if the received evaluation trade request is executed, the method proceeds to step 512. Otherwise, the method proceeds to step 506.

At step 506, a determination is made as to whether the account balance of the evaluation trading account will drop below a daily loss limit amount if the received evaluation trade request is executed. If it is determined that the account balance will drop below the daily loss limit amount if the received evaluation trade request is executed, the method proceeds to step 512. Otherwise, the method proceeds to step 508.

At step 508, a determination is made as to whether executing the received evaluation trade request will cause an account contract list of the evaluation trading account to exceed a maximum position size. If it is determined that executing the received evaluation trade request will cause the account contract list to exceed the maximum position size, the method proceeds to step 512. Otherwise, the method proceeds to step 510.

If the method proceeds to step 510, the received evaluation trade request is executed in the simulated trading environment. If, instead, the method proceeds to step 512, the received evaluation request is rejected.

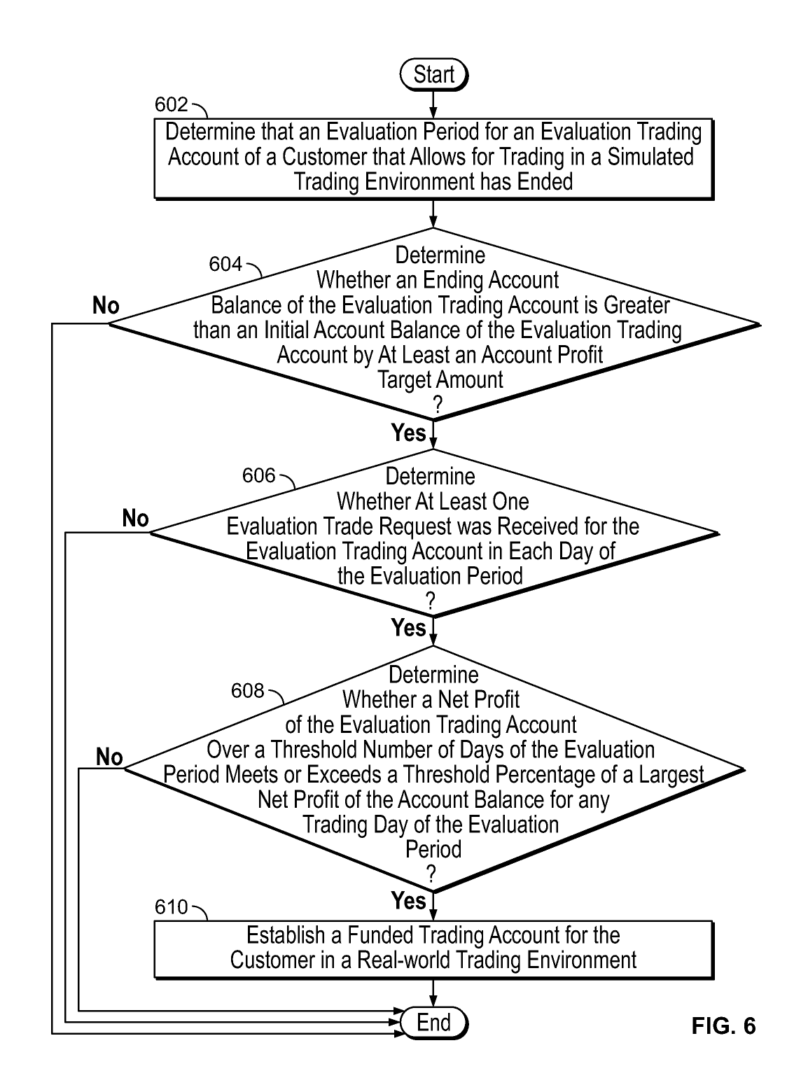

FIG. 6 is a flowchart of yet another example method that can be carried out by an application server, such as the application server 102 of FIG. 1. At step 602, a determination is made that an evaluation period for an evaluation trading account of a customer that allows for trading in a simulated trading environment has ended. At step 604, a determination is made as to whether an ending account balance of the evaluation trading account is greater than an initial account balance of the evaluation trading account by at least an account profit target amount. If it is determined that the ending account balance is greater than the initial account balance by at least the account profit target amount, the method proceeds to step 606. Otherwise the method ends.

At step 606, a determination is made as to whether at least one evaluation trade request was received for the evaluation trading account in each day of the evaluation period. If it is determined that at least one evaluation trade request was received in each day of the evaluation period, the method proceeds to step 608. Otherwise the method ends.

At step 608, a determination is made as to whether a net profit of the evaluation trading account over a threshold number of days of the evaluation period meets or exceeds a threshold percentage of a largest net profit of the account balance for any trading day of the evaluation period. If the net profit over the threshold number of days meets or exceeds the threshold percentage of the largest net profit of any trading day of the evaluation period, the method proceeds to step 610. Otherwise the method ends.

At step 610, a funded trading account is established for the customer in a real-world trading environment.

Appendix A includes additional information and is part of these disclosures.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A method for qualifying traders by a computing device, the method comprising:
establishing an evaluation trading account for a customer in a simulated trading environment, wherein the evaluation trading account is associated with a set of evaluation trading account rules, and comprises an account contract list, an account balance, an account profit target amount, an account maximum drawdown amount, and an account daily loss limit amount;
receiving a plurality of evaluation trade requests, each for at least one contract, for the evaluation trading account over a plurality of trading days;
determining the real-time market value for each contract received in the plurality of evaluation trade requests;
executing the plurality of evaluation trade requests in the simulated trading environment based on the determined real-time market value for each contract;
updating the account contract list and the account balance of the evaluation trading account based on the execution of each of the plurality of evaluation trade requests;
determining whether the evaluation account satisfies the set of evaluation trading account rules; and
based on determining that the evaluation account satisfies the evaluation trading account rules, establishing a funded trading account for the customer in a real-world trading environment, wherein the funded trading account allows for contract trading in the real-world.

2. The method of claim 1, further comprising updating the account balance of the evaluation trading account with an initial balance.

3. The method of claim 2, wherein determining whether the evaluation account satisfies the set of evaluation trading account rules comprises determining that the updated account balance is greater than the initial account balance by at least the account profit target amount at the end of the plurality of trading days.

4. The method of claim 1, wherein determining whether the evaluation account satisfies the set of evaluation trading account rules comprises determining whether the account balance went below the account maximum drawdown amount during the plurality of trading days, and further comprising terminating the evaluation account if the account balance is determined to go below the account maximum drawdown amount.

5. The method of claim 1, wherein determining whether the evaluation account satisfies the set of evaluation trading account rules comprises determining that at least one evaluation trade request of the plurality of evaluation requests were received in each trading day of the plurality of trading days.

6. The method of claim 1, wherein executing the plurality of evaluation trade requests in the simulated trading environment comprises:
determining that executing an evaluation trade request of the plurality of evaluation trade requests will cause the account balance to go below the account daily loss limit amount in a current trading day of the plurality of trading days; and
if it is determined that the account balance will go below the account daily loss limit, rejecting the evaluation trade request that will cause the account balance to go below the account daily loss limit in the current trading day.

7. The method of claim 1, wherein executing the plurality of evaluation trade requests in the simulated trading environment comprises:
determining that executing an evaluation trade request of the plurality of evaluation trade requests will cause the account contract list to exceed a maximum position size; and
rejecting the evaluation trade request that will cause the account contract list to exceed the maximum position size.

8. The method of claim 1, wherein determining whether the evaluation account satisfies the set of evaluation trading account rules comprises determining that a net profit of the account balance, for any threshold number of trading days of the plurality of trading days, meets or exceeds a threshold percentage of a largest net profit of the account balance for any trading day of the plurality of trading days.

9. A computing device comprising one or more processors configured to:
establish an evaluation trading account for a customer in a simulated trading environment, wherein the evaluation trading account is associated with a set of evaluation trading account rules, and comprises an account contract list, an account balance, an account profit target amount, an account maximum drawdown amount, and an account daily loss limit amount;
receive a plurality of evaluation trade requests, each for at least one contract, for the evaluation trading account over a plurality of trading days;
determine the real-time market value for each contract received in the plurality of evaluation trade requests;
execute the plurality of evaluation trade requests in the simulated trading environment based on the determined real-time market value for each contract;
update the account contract list and the account balance of the evaluation trading account based on the execution of each of the plurality of evaluation trade requests;
determine whether the evaluation account satisfies the set of evaluation trading account rules; and
based on determining that the evaluation account satisfies the evaluation trading account rules, establish a funded trading account for the customer in a real-world trading environment, wherein the funded trading account allows for contract trading in the real-world.

10. The computing device of claim 9, wherein the one or more processors configured to update the account balance of the evaluation trading account with an initial balance.

11. The computing device of claim 10, wherein the one or more processors configured to determine that the updated account balance is greater than the initial account balance by at least the account profit target amount at the end of the plurality of trading days.

12. The computing device of claim 9, wherein the one or more processors configured to determine whether the account balance went below the account maximum drawdown amount during the plurality of trading days, and terminate the evaluation account if the account balance is determined to go below the account maximum drawdown amount.

13. The computing device of claim 9, wherein the one or more processors configured to determine that at least one evaluation trade request of the plurality of evaluation requests were received in each trading day of the plurality of trading days.

14. The computing device of claim 9, wherein the one or more processors configured to:
determine that executing an evaluation trade request of the plurality of evaluation trade requests will cause the account balance to go below the account daily loss limit amount in a current trading day of the plurality of trading days; and
if it is determined that the account balance will go below the account daily loss limit, reject the evaluation trade request that will cause the account balance to go below the account daily loss limit in the current trading day.

15. The computing device of claim 9, wherein the one or more processors configured to:
determine that executing an evaluation trade request of the plurality of evaluation trade requests will cause the account contract list to exceed a maximum position size; and
reject the evaluation trade request that will cause the account contract list to exceed the maximum position size.

16. The computing device of claim 9, wherein the one or more processors configured to determine that a net profit of the account balance, for any threshold number of trading days of the plurality of trading days, meets or exceeds a threshold percentage of a largest net profit of the account balance for any trading day of the plurality of trading days.

17. A non-transitory, computer-readable storage medium comprising executable instructions which, when executed by one or more processors, causes the one or more processors to:
establish an evaluation trading account for a customer in a simulated trading environment, wherein the evaluation trading account is associated with a set of evaluation trading account rules, and comprises an account contract list, an account balance, an account profit target amount, an account maximum drawdown amount, and an account daily loss limit amount;
receive a plurality of evaluation trade requests, each for at least one contract, for the evaluation trading account over a plurality of trading days;
determine the real-time market value for each contract received in the plurality of evaluation trade requests;
execute the plurality of evaluation trade requests in the simulated trading environment based on the determined real-time market value for each contract;
update the account contract list and the account balance of the evaluation trading account based on the execution of each of the plurality of evaluation trade requests;
determine whether the evaluation account satisfies the set of evaluation trading account rules; and
based on determining that the evaluation account satisfies the evaluation trading account rules, establish a funded trading account for the customer in a real-world trading environment, wherein the funded trading account allows for contract trading in the real-world.

18. The computer-readable storage medium of claim 17, wherein the executable instructions, when executed by the one or more processors, cause the one or more processors to update the account balance of the evaluation trading account with an initial balance.

19. The computer-readable storage medium of claim 18, wherein the executable instructions, when executed by the one or more processors, cause the one or more processors to determine that the updated account balance is greater than the initial account balance by at least the account profit target amount at the end of the plurality of trading days.

20. The computer-readable storage medium of claim 17, wherein the executable instructions, when executed by the one or more processors, cause the one or more processors to determine whether the account balance went below the account maximum drawdown amount during the plurality of trading days, and terminate the evaluation account if the account balance is determined to go below the account maximum drawdown amount.
